(19) United States
(12) Patent Application Publication
(10) Pub. No.: US 2026/0318510 A1
(43) Pub. Date: Oct. 15, 2026

(54) LIGHT ENGINE FOR INCORPORATION INTO LUMINAIRE

(71) Applicant: SIGNIFY HOLDING B.V., EIDHOVEN (NL)

(72) Inventors: SERGIO FABIAN JURDANA, BLAINVILLE (CA); JEAN-FRANCOIS LAPORTE, MASCOUCHE (CA); ALEXANDRE PLOMTEUX, MONTREAL (CA)

(21) Appl. No.: 19/484,442

(22) PCT Filed: Jun. 3, 2024
(86) PCT No.: PCT/EP2024/065176

§ 371 Date: Nov. 14, 2025

Related U.S. Application Data
(60) Provisional application No. 63/471,985, filed on Jun. 9, 2023.
(60) Provisional application No. 63/532,514, filed on Aug. 14, 2023.

(30) Foreign Application Priority Data
Sep. 22, 2023 (EP) 23198965.8

(51) Int. Cl. F21V 19/00; F21K 9/90; F21V 23/00; F21V 23/06; F21V 25/10; F21V 31/00; F21Y 105/16; F21Y 115/10

(52) U.S. Cl. CPC F21V 19/004; F21K 9/90; F21V 19/005; F21V 23/006; F21V 23/06; F21V 25/10; F21V 31/005; F21Y 2105/16; F21Y 2115/10

(57) ABSTRACT

According to certain embodiments, an apparatus comprises: a driver including: a printed circuit board (PCB) comprising a top surface and a rear surface; and a light engine interface disposed on the rear surface of the PCB; a housing including: a hole; and a retaining ledge disposed at a periphery of the housing; and a light engine including: a substrate having a top surface, a rear surface, and a side surface; a light engine connector disposed on the top surface of the substrate; a plurality of light emitting diodes (LEDs) disposed on the rear surface of the substrate, wherein the plurality of LEDs is electrically connected to the light engine connector; and a plurality of clips disposed on the side surface of the substrate, the plurality of clips configured to resist an inward lateral force; wherein the plurality of clips fastens the substrate to the housing, and wherein the light engine connector and the light engine interface protrude through the hole and are electrically connected to each other.

### FIELD OF THE INVENTION

The disclosure relates to light engines that can be incorporated into a luminaire. More particularly, the disclosure relates to a light engine that can attach to a rear surface of a Printed Circuit Board (PCB) and reduce the air gap, therebetween.

### DESCRIPTION OF THE RELATED ART

A luminaire includes a light engine and a driver. A light engine can include light emitting diodes (LEDs) and other optics. The driver includes electronic components that control the voltage and current to the LEDs.

It should be noted that the above information of the background is merely provided for clear and complete explanation of the disclosure and for easy understanding for those skilled in the art. No inference should be drawn that any of the above information is known to those skilled in the art.

US 2017/321868 A1 relates to a lighting-means carrier for a strip-lighting luminaire, comprising at least one lighting-means circuit board having light-emitting diodes that can be arranged thereon; and at least one heat sink thermally connected to the lighting-means circuit board. In a central region, the lighting-means circuit board is rigidly connected to the heat sink in such a way that substantially no relative motion between the lighting-means circuit board and the heat sink is possible. In at least two further regions, the lighting-means circuit board is connected to the heat sink in a floating manner, the lighting-means circuit board therefore being arranged on the heat sink in such a way that the lighting-means circuit board can be moved in relation to the heat sink outside of the central region.

### SUMMARY OF THE INVENTION

According to certain embodiments, an apparatus comprises: a driver including: a printed circuit board (PCB) comprising a top surface and a rear surface; and a light engine interface disposed on the rear surface of the PCB; a housing including: a hole; and a retaining ledge disposed at a periphery of the housing; and a light engine including: a substrate having a top surface, a rear surface, and a side surface; a light engine connector disposed on the top surface of the substrate; a plurality of light emitting diodes (LEDs) disposed on the rear surface of the substrate, wherein the plurality of LEDs is electrically connected to the light engine connector; and a plurality of clips disposed on the side surface of the substrate, the plurality of clips configured to resist an inward lateral force; wherein the plurality of clips fastens the substrate to the housing, and wherein the light engine connector and the light engine interface protrude through the hole and are electrically connected to each other.

According to certain embodiments, a method for assembling a luminaire comprises: applying an outward lateral force by a plurality of clips of a light engine; applying an inward lateral force by protrusions of a retaining ledge of a housing; and applying a pressing force against the light engine, thereby causing the plurality of clips to push the protrusions outwards, or the protrusions to push the plurality of clips inwards, until the protrusions are below the clips.

### BRIEF DESCRIPTION OF THE DRAWINGS

The above and other aspects, features, and advantages of certain embodiments of the disclosure will be more apparent from the following description taken in conjunction with the accompanying drawings, in which:

A brief description of each drawing is provided to better understand the drawings cited herein.

FIG. 1 is an illustration of a luminaire in accordance with an embodiment of the disclosure;

FIG. 2A is an illustration of a view of the light engine from the rear surface in accordance with an embodiment of the disclosure;

FIG. 2B is an illustration of a cross-section of the light engine in accordance with an embodiment of the disclosure;

FIG. 2C is an illustration of a clip in accordance with an embodiment of the disclosure;

FIG. 2D is an illustration of a top view of the clip in accordance with an embodiment of the disclosure;

FIG. 3A illustrates the mating of the clips of the light engine with the retaining ledge in accordance with an embodiment of the disclosure;

FIG. 3B illustrates the mating of the clips of the light engine with the retaining ledge in accordance with an embodiment of the disclosure;

FIG. 3C illustrates a fastening of the housing with the light engine with glue in accordance with an embodiment of the disclosure;

FIG. 4A illustrates a driver in accordance with an embodiment of the disclosure;

FIG. 4B illustrates another driver in accordance with an embodiment of the disclosure;

FIG. 5 illustrates a surge protector device in accordance with an embodiment of the disclosure;

FIG. 6 is a flow diagram of a method of manufacturing a luminaire.

### DETAILED DESCRIPTION

A light engine may be connected to a driver for proper operation. While the light engine and driver may be connected by wires, wire routing management is complex. For example, it is desirable to position the wires to avoid pinching by the housing, and friction from movement during vibration of the luminaire. Deterioration due to contact with water can be a concern, especially because certain luminaires are rated to receive and drain water.

Other difficulties with wires include cost and space, complexities in assembly, electromagnetic interferences, and having to reconnect wires when replacing components.

Accordingly, in certain embodiments, a light engine that can be incorporated into a luminaire that may reduce, if not eliminate, wires. The wires that connected the light engine and the driver can be replaced by connectors and traces printed on a PCB.

Certain embodiments may provide one or more of the following advantages: merged electronic components, eliminating driver casing, integrating the NEMA socket, reducing part count, eliminating fasteners and wires, allowing for a simpler and faster luminaire assembly, reducing, if not eliminating, signal interferences caused by signal interferences between wires, and allowing robotic assembly.

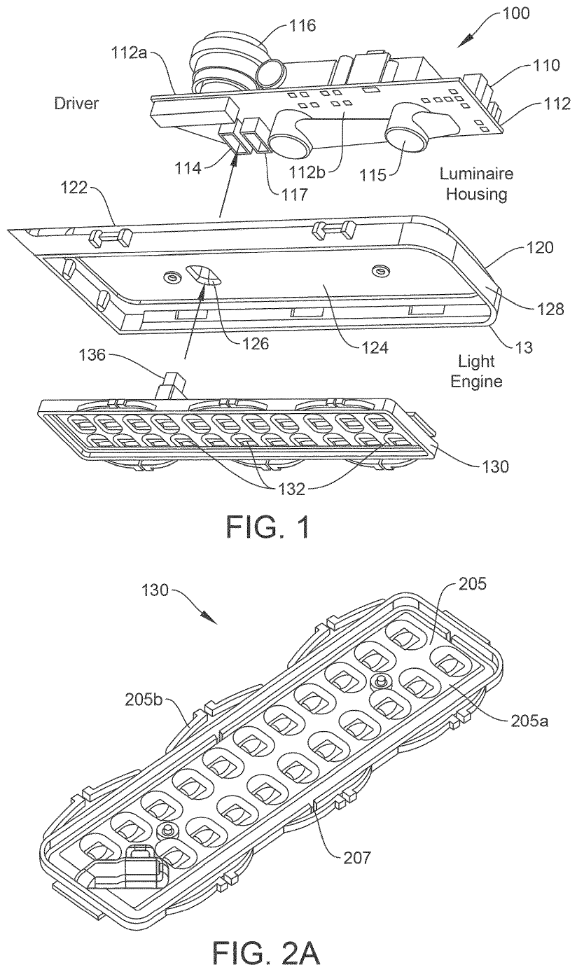

Referring to FIG. 1, there is illustrated a luminaire in accordance with an embodiment of the disclosure. The luminaire 100 includes a driver 110, a surge protector device 115, a housing 120, and a light engine 130.

The light engine 130 can be generally planar with two surfaces facing opposite directions. The light engine 130 can include a plurality of LEDs 132 and optic members disposed on one side. The light engine can include a light engine connector 136 disposed on the other side. The light engine connector 136 can provide an electrical connection to the LEDs 132. Additionally, the light engine 130 can include clips (not shown in FIG. 1) that fasten the light engine 130 to the housing 120.

The housing 120 can include a top surface 122, a rear surface 124, a hole 126 and a retaining ledge 128 surrounding the rear surface 124. The rear surface 124 can make contact with a surface of the light engine 130 and provide a surface contact for heat dissipation. Moreover, the hole 126 can correspond the location of the light engine connector 136, thus allowing the light engine connector 136 to protrude through the hole 128. The retaining ledge 128 can include protrusions (not shown in FIG. 1) for engaging the clips of the light engine 130.

The protrusions from the retaining ledge 128 of the housing 120 may engage the clips of the light engine 130 to fix the light engine 130 in a position such that the surface of the light engine 130 provides a pressing force against the rear surface 124 of the housing 120. The pressing force can substantially reduce, if not eliminate an air gap between the rear surface 124 of the housing 120 and the light engine 130, while maximizing heat dissipation from the LEDs 132 to the housing 120.

The driver 110 can include a PCB 112 and electronic components disposed on the PCB 112. The PCB 112 can have a top surface 112a and a rear surface 112b. The electronic components can include a light engine interface 114, a socket 116, and a block connector 117, and a surge protector connector (not shown in FIG. 1). The light engine interface 114 can be disposed on the rear surface 112b of the PCB 112. The light engine interface 114 receives electrical connection, via conductive traces on the PCB, to the other electronic components. The light engine interface 114 can receive and form an electrical connection with the light engine connector 136. The electrical connection between the light engine interface 114 and the light engine connector 136, allows the electronic components disposed on the PCB to control the LEDs 132.

The socket 116 can comprise a National Electrical Manufacturers Association (NEMA) socket 116. NEMA sockets 116 are largely used on outdoor luminaires. In certain embodiments, the NEMA socket 116 can also be used to receive and send information, provide luminaire status, or react depending on programmed functions. In certain embodiments, a number of NEMA devices can be installed on the NEMA socket 116, including a photocell control, shorting caps, and control devices with multiple functions. While the remaining embodiments in this disclosure use a NEMA socket 116 by way of example, it shall be understood that different sockets can be used.

A block connector 117 is connected to the rear surface 112b of the PCB 112. The block connector 117 is configured to receive power from a power cord, and configured to provide power to the LEDs 132, via the light engine interface 114 and light engine connector 136. The surge protector device 115 is connected to the rear surface 112b of the PCB 112 and configured to dissipate excess power. That is, the surge protector device 115 controls the connection between the block connector 117 and the other electrical components and the light engine interface 114. During a power surge or power spike (collectively referred to as a power surge), the surge protector device 115 receives the power from the block connector 117, dissipates the excess power, and provides the remaining power to the PCB 112, and other electronic components, including the light engine interface 114. This protects the PCB 112, other electronic components, including the light engine interface 114 from overvoltage and overcurrent damage.

Thus, when the block connector 117 is connected to an electrical outlet, and the surge protector device 115 is connected to the PCB 112, the light engine interface 114 and light engine connector 136 provide power to the LEDs 132. The surge protector device 115 prevents damage from power surges, while the electronic components on the PCB 112 control the voltage and current provided to the LEDs 132. When the LEDs 132 receive power, the LEDs 132 convert the power to light. In certain embodiments, the surge protector device 115 can be omitted.

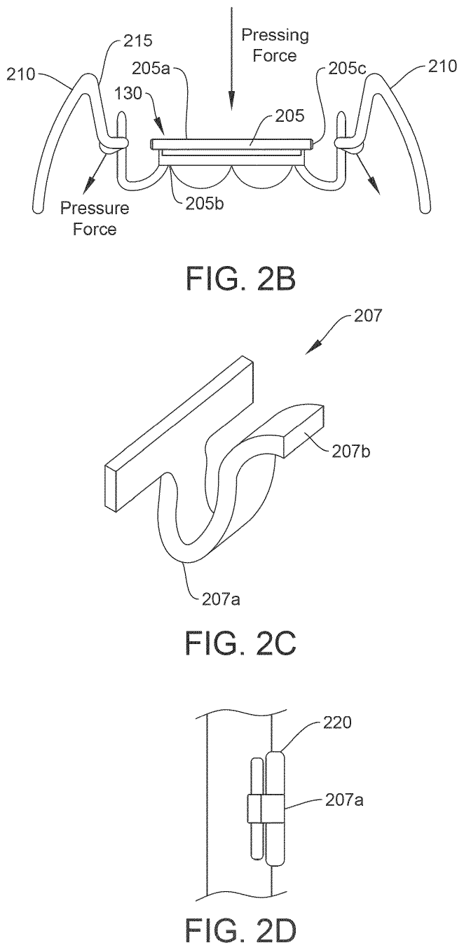

Referring to FIG. 2A, there is illustrated a view of the light engine 130 from the rear surface in accordance with an embodiment of this disclosure. The light engine 130 can include a substrate 205. The substrate 205 can have a top surface 205a, a rear surface 205b, and clips 207 surrounding a side surface 205c of the substrate 205. In certain embodiments, the substrate 205 and one or more clips 207 can be formed by a plastic molded part, such that the clips 207 are integral to the substrate 205.

In certain embodiments, the one or more clips 207 can comprise a single clip 207 that surrounds the side surface 205c of the substrate 205. In another embodiment, the one or more clips 207 can comprise a plurality of clips 207 disposed uniformly or regularly spaced apart from one another at the periphery.

The LEDs 132 can be disposed on the rear surface 205b, while the light engine connector 136 can be disposed on the top surface 205a.

Referring now to FIG. 2B, there is illustrated a cross-section of the light engine 130. The light engine 130 includes the substrate 205. Clips 207 are attached to the side surface 205c of the substrate 205. The clips 207 are configured to provide a lateral force away from the substrate 205, and resist an inward force. The clips 207 can be pressed against opposing flanges 210 with protrusions 215 at the tip. The flanges 210 can apply an inward lateral force, and resist and outward lateral force. When a sufficient pressing force presses the light engine 130 against the flanges 210, the curved portion of the clips 207 applies an outward force against the flanges 210. The protrusions 215 guide the curve portion of the clips 207 in the pressing direction, causing the flanges 210 to bend outward. When the ends of the clips 207 are pushed past the protrusions 215, the outward force is released, causing the flanges 210 to move inwards and the clips 207 to move outwards. Accordingly, the protrusions 215 become positioned inside the curve of the clips 207 and resist a force, such as gravity, that is opposite of the pressing direction. As a result, the light engine 130 can be fixed into a position.

Referring now to FIG. 2C, there is illustrated a clip 207 in accordance with an embodiment of the disclosure. The clip 207 includes a curved portion 207a, and a tip 207b. The tip 207b can apply a lateral force, while the curved portion 207a can receive a structure that resists downward movement.

Referring now to FIG. 2D, there is illustrated a top view of the clip 207 in accordance with an embodiment of the disclosure. An opposing structure 220 is disposed in the curved portion 207a, thereby opposing a downward movement of the clip 207.

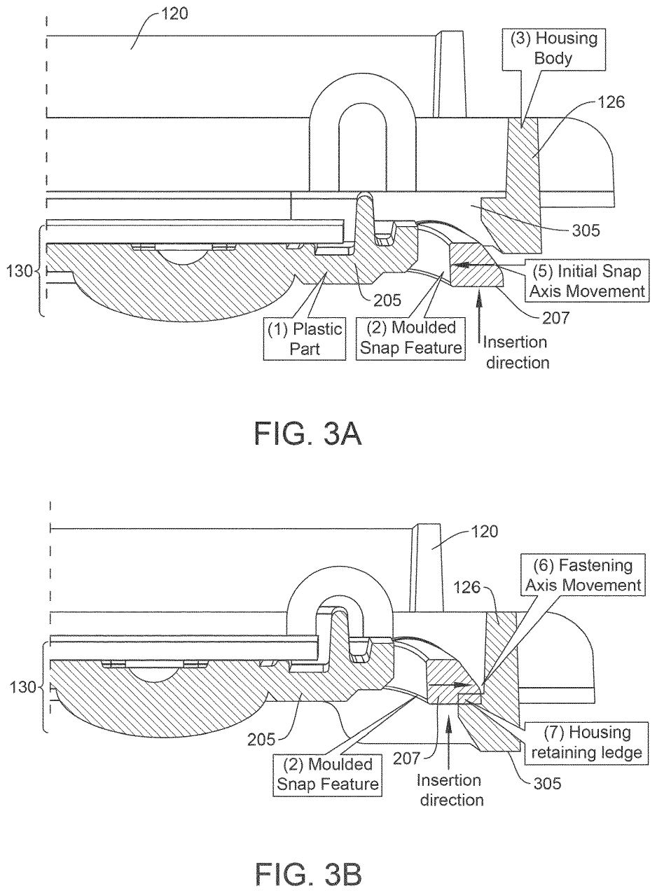

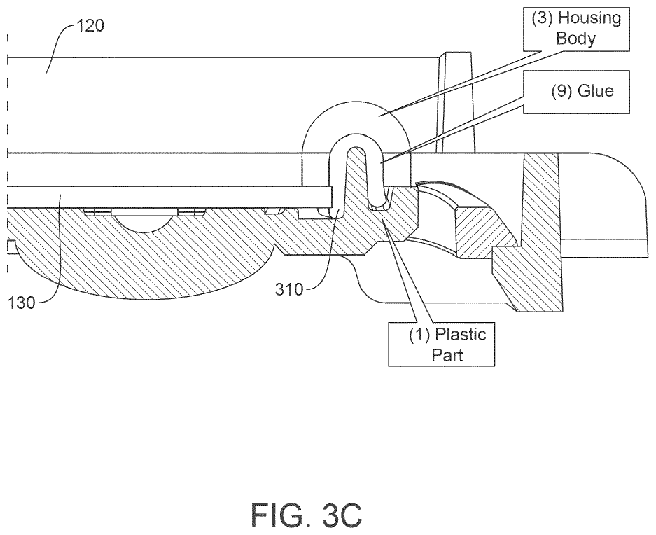

Referring to FIGS. 3A and 3B, there is illustrated the mating of the clips 207 of the light engine 130 with the retaining ledge 128. The clips 207 can be plastic molded as part of the plastic body forming the substrate 205. To fasten the substrate 205 to the housing 120, the substrate 205 inserted onto the housing in the insertion direction. To allow the substrate 205 to be inserted, the clip 207 must move along an axis perpendicular axis to the insertion axis. The sloped surfaces of the interface between the clip 207 and the housing 120 facilitates this moving of the clip 207 in the side movement.

To fasten the substrate 205 to the housing 120, the clip 207 is pushed up and past protrusions 305 on the housing retaining ledge 128. This can be done by applying pressure to the clip 207 along the insertion direction. Once the clip 207 is past the protrusions 305, the clip 207 can move along the fastening axis. In certain embodiments, there is an interference between the clip 207 and the housing 120 because of a designed in secondary axis that will apply pressure as a result of the force of the clip 207 insertion.

Once the initial clip 207 is moved past the protrusions 305 on the housing retaining ledge 128, there is no more pressure on the fastening axis (5 & 6). The interference between the clip 207 and the housing 120 is now applying a force between the substrate of the light engine 130 and the housing 120 results from a force being applied to the substrate 205 to be held onto the housing 120 with an opposite and equal force to the sum of all the clip features. Depending on the force to be applied, the clip 207 interference and quantity of clips 207 can be determined and designed-in to the plastic mold forming the substrate 205 and clips 207.

Referring to FIG. 3C, there is illustrated a fastening of the housing 120 with the light engine 130 with glue 310. This foregoing can be applied in various situations where there is a need to assemble parts and to assure a constant pressure to the parts to be held firmly to each other. In the current embodiment, it may guarantee a certain amount of force for good thermal contact to the housing 120.

A second fail-proof fastening occurs when combined with a glue 310 that will cure during the initial assembly. Once the glue is fully cured, this glue will also hold the parts together, maintain the pressure applied by the clip 207 and provide IP 66 water-tight protection.

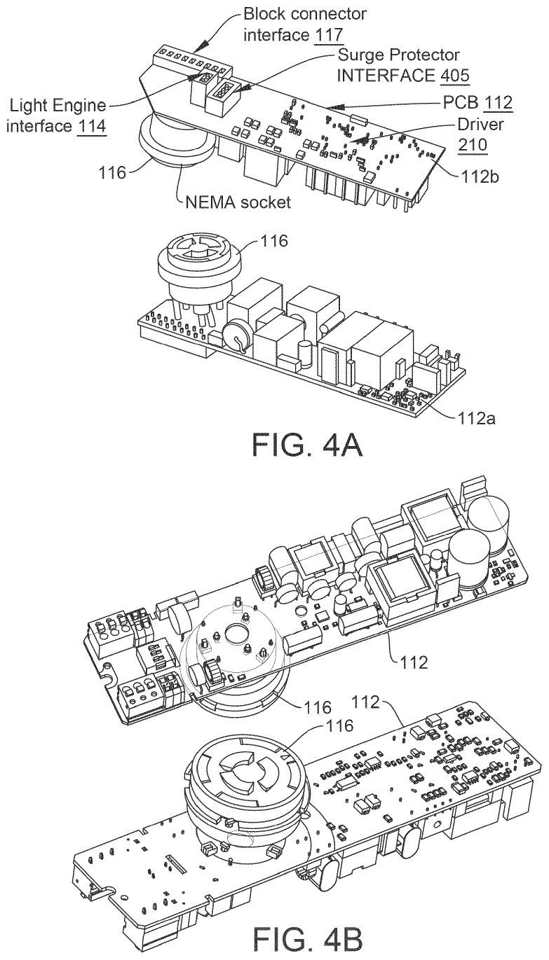

Referring now to FIG. 4A, there is illustrated a driver 110 in accordance with an embodiment of this disclosure. The driver 110 includes the PCB 112. The PCB 112 can have the top surface 112a and the rear surface 112b. The light engine interface 114 is disposed on the rear surface 112b of the PCB 112 and forms electrical connection, via conductive traces on the PCB, to the other electronic components. Additionally, the light engine interface 114 facilitates connection to the light engine 130, via the light engine connector 136.

Additionally, in certain embodiments, the driver 110 can include a surge protector interface 405 on the rear surface 112b of the PCB 112. The surge protector interface 405 facilitates connection to a surge protector. The surge protector interface 405 can have one terminal that is electrically connected to the block connector 117, and one terminal that is electrically connected to the PCB 112 and other electronic components including the light engine interface 114.

In other embodiments, the driver 110 can omit the surge protector interface, such that the block connector 117 is electrically connected to the electronic components including the light engine interface 114.

The NEMA socket 116 can be disposed on the top surface 112a of the PCB 112. The NEMA socket 116 can facilitate connection of the electronic devices to the luminaire 100. The NEMA socket 116 can be installed on the PCB 112 as a pick and place components and welded in accordance with a standard manufacturing process for electronic components.

It is noted that in certain embodiments, as shown in FIG. 4B, the NEMA socket 116 can be disposed on the rear surface 112b of the PCB.

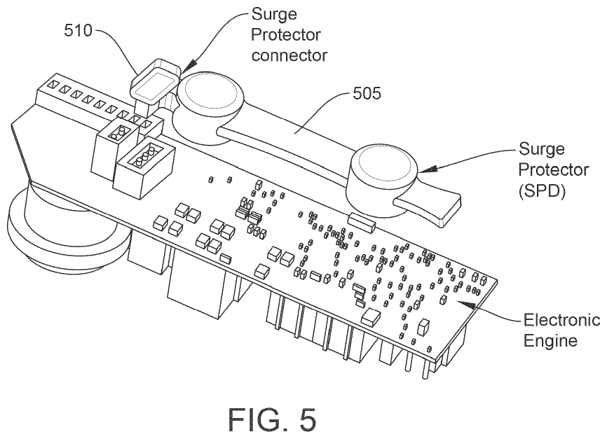

Referring now to FIG. 5, there is illustrated a surge protector device 500. The surge protector device 500 comprises a surge protector 505 and a surge protector connector 510. The surge protector connector 510 can be configured to form an electrical connection with each terminal of the surge protector interface 405. The surge protector 505 can include an electrical path that forms a circuit with the terminals of the surge protector interface 405. The electrical path operates as a short circuit for power below a predetermined amount, and dissipates power above the predetermined amount.

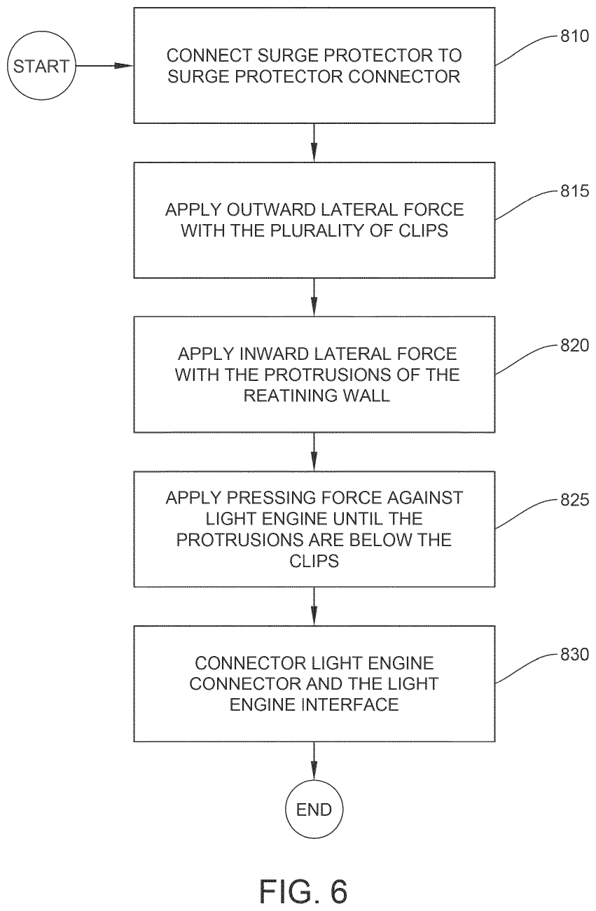

Referring now to FIG. 6 there is illustrated a flow diagram for a method of manufacturing a luminaire in accordance with an embodiment of the disclosure. Certain operations can be performed by, for example, a robot. It is noted that the steps can be performed in a variety of orders, and not necessarily in the order recited. At 810, the surge protector 410 is connected to the surge protector interface 405 of the driver 110.

The light engine 130 can be connected to the housing 120, causing the light engine connector 136 to pass through hole 126. Connecting the light engine 130 to the housing 120 can include 815-825. At 815, the plurality of clips 207 of the light engine 130 apply an outward lateral force. At 820, the protrusions 305 of the retaining ledge 128 of the housing 120 apply an inward later force. At 825, a pressing force is applied against the light engine 130, thereby causing the plurality of clips 207 to push the protrusions 305 outwards, or vice versa, until the protrusions 305 are below the clips 207.

At 830, the light engine connector 136 and the light engine interface 114 are connected.

This invention can be applied in various situations to assemble parts and to assure a constant pressure to the parts to be held firmly to each other. In certain embodiments, there is sufficient force for good thermal contact of the light engine 130 to the housing 120.

Additionally, glue can be used to cure during the initial assembly. Once the glue is fully cured, this glue will also hold the parts together and maintain the pressure the clip 207 is also applying and provide IP 66 water-tight protection.

According to certain embodiments, an apparatus 100 comprises a driver 110 including a printed circuit board (PCB) 112 comprising a top surface 112a and a rear surface 112b; and a light engine interface 114 disposed on the rear surface of the PCB 112b; a housing 120 including: a hole 126; and a retaining ledge 128 disposed at a periphery of the housing 120; and a light engine 130 including: a substrate 205 having a top surface 205a, a rear surface 205b, and a side surface 205c; a light engine connector 136 disposed on the top surface of the substrate 205a; a plurality of light emitting diodes (LEDs) 132 disposed on the rear surface of the substrate 205b, wherein the plurality of LEDs 132 is electrically connected to the light engine connector 136; and a plurality of clips 207 disposed on the side surface of the substrate 205c, the plurality of clips 207 configured to resist an inward lateral force; wherein the plurality of clips 207 fastens the substrate 205 to the housing 120, and wherein the light engine connector 136 and the light engine interface 114 protrude through the hole 126 and are electrically connected to each other.

According to certain embodiments, the substrate 205 and the plurality of clips comprise plastic 207.

According to certain embodiments, at least one of the plurality of clips comprises:
a curved portion 207a, and a tip 207b.

According to certain embodiments, the tip 207b is configured to exert an outward lateral resisting an inward lateral force.

According to certain embodiments, the retaining ledge 128 includes protrusions 305, and wherein the plurality of clips 207 is engaged with the protrusions 205.

According to certain embodiments, the plurality of clips 207 provide an outward force, and the protrusions 305 provide an inward force, and the protrusions 305 are below the plurality of clips 207.

According to certain embodiments, the driver 110 further comprises a block connector 117 disposed on the PCB 112, the block connector 117 configured to receive power and configured to provide at least some of the power to the plurality of LEDs 132 through the light engine interface 114 and the light engine connector 136.

According to certain embodiments, the driver 110 comprises a socket 116 disposed on the PCB 112, the socket 116 configured to electrically connect the apparatus with another electronic device.

According to certain embodiments, the apparatus further comprises a surge protector 505 controlling an electrical connection between the block connector 117 and the plurality of LEDs 132, wherein the surge protector 505 is configured to dissipate an amount of the power that exceeds a predetermined amount.

According to certain embodiments, the apparatus comprises a surge protector interface 405 disposed on the rear surface of the PCB 112b, and wherein the surge protector 505 is connected to the surge protector interface 405 by a surge protector connector 510.

According to certain embodiments, a method for assembling a luminaire comprises: applying an outward lateral force 815 by a plurality of clips 207 of a light engine 130; applying an inward lateral force 820 by protrusions 305 of a retaining ledge 128 of a housing 120; and applying a pressing force 825 against the light engine 130, thereby causing the plurality of clips 207 to push the protrusions outwards 305, or the protrusions 305 to push the plurality of clips 207 inwards, until the protrusions 305 are below the plurality of clips 207.

According to certain embodiments, the housing 120 comprises a hole 126, wherein the light engine 130 comprises a light engine connector 136, and wherein the light engine connector 136 protrudes through the hole 128 when the protrusions 305 are below the plurality of clips 207.

According to certain embodiments, the method further comprises connecting 810 a surge protector device 115 to a driver 110, wherein the driver 110 comprises a printed circuit board 112 and a light engine interface 114; and connecting 830 the light engine connector 136 to the light engine interface 114.

According to certain embodiments, the plurality of clips 207 comprises plastic.

According to certain embodiments, at least one of the plurality of clips 207 comprises a curved portion 207a, and a tip 207b.

While one or more embodiments of the disclosure have been described with reference to the figures, it will be understood by those of ordinary skill in the art that various changes in form and details may be made therein without departing from the spirit and scope as defined by the following claims.

1. An apparatus comprising:
a driver including:
a printed circuit board (PCB) comprising a top surface and a rear surface; and
a light engine interface disposed on the rear surface of the PCB; a housing including:
a hole; and
a retaining ledge disposed at a periphery of the housing; and
a light engine including:
a substrate having a top surface, a rear surface, and a side surface;
a light engine connector disposed on the top surface of the substrate;
a plurality of light emitting diodes (LEDs) disposed on the rear surface of the substrate wherein the plurality of LEDs is electrically connected to the light engine connector;
wherein the light engine connector and/or the light engine interface protrude through the hole and are electrically connected to each other; and
a plurality of clips disposed on the side surface of the substrate, the plurality of clips configured to resist an inward lateral force, and wherein the plurality of clips fastens the substrate to the housing.

2. (canceled)

3. The apparatus of claim 1, wherein at least one of the plurality of clips comprises:
a curved portion; and
a tip.

4. The apparatus of claim 3, wherein the tip is configured to exert an outward lateral resisting the inward lateral force.

5. The apparatus of claim 1, wherein the retaining ledge includes protrusions, and wherein the plurality of clips is engaged with the protrusions.

6. The apparatus of claim 5, wherein the plurality of clips provides an outward force, and the protrusions provide an inward force, and the protrusions are below the plurality of clips.

7. The apparatus of claim 6, wherein the driver further comprises a block connector disposed on the PCB, the block connector configured to receive power and configured to provide at least some of the power to the plurality of LEDs through the light engine interface and the light engine connector.

8. The apparatus of claim 7, wherein the driver comprises a socket disposed on the PCB, the socket configured to electrically connect the apparatus with another electronic device.

9. The apparatus of claim 7, further comprising a surge protector controlling an electrical connection between the block connector and the plurality of LEDs, wherein the surge protector is configured to dissipate an amount of the power that exceeds a predetermined amount.

10. The apparatus of claim 9, wherein the PCB comprises a surge protector interface disposed on the rear surface of the PCB, and wherein the surge protector is connected to the surge protector interface by a surge protector connector.

11. A method for assembling a luminaire, wherein said luminaire includes a housing having a hole, a light engine including a light engine connector, and driver having a light engine interface said method comprising:
connecting the light engine connector to the light engine interface, wherein the light engine connector and/or the light engine interface protrude through the hole; and
connecting a surge protector device to the driver, wherein the driver comprises a printed circuit board and the light engine interface;
applying an outward lateral force by a plurality of clips of the light engine;
applying an inward lateral force by protrusions of a retaining ledge of the housing; and
applying a pressing force against the light engine, thereby causing the plurality of clips to push the protrusions outwards, or the protrusions to push the plurality of clips inwards, until the protrusions are below the plurality of clips.

12. (canceled)

13. The method of claim 11, wherein the plurality of clips comprises plastic.

14. The method of claim 11, wherein at least one of the plurality of clips comprises a curved portion, and a tip.
